(19) United States
(12) Patent Application Publication
(10) Pub. No.: US 2012/0285804 A1
(43) Pub. Date: Nov. 15, 2012

(54) Conveying System for Agricultural Machines

(76) Inventors: Johan Oord, Groningen (NL); Jan Harm Mulder, Dalen (NL); Sebastian Jäger, Hannover (DE)

(21) Appl. No.: 13/449,528

(22) Filed: Apr. 18, 2012

(30) Foreign Application Priority Data
Apr. 18, 2011 (DE) 102011017426.5-23

(51) Int. Cl. B65G 15/62

(52) U.S. Cl. 198/832

(57) ABSTRACT

A conveying system for agricultural machines, comprised a housing, and a modular conveying mechanism configured to be introduced into the housing and to be detachably connected thereto, wherein the conveying mechanism is provided with drive mechanisms and guide mechanisms. The conveying mechanism includes an endless conveyor that rotates about the drive mechanism and the guide mechanism. The conveying mechanism is provided with a self-supporting frame structure in which the drive mechanisms and the guide mechanisms are rotatably mounted.

The present invention relates to a conveying system for agricultural machines, and is comprised of a conveying mechanism and a housing pursuant to the introductory portion of claim 1.

Such a conveying system is known, for example, from DE 602 22 881 T2. This conveying system is an inclined conveyor for agricultural harvesting machines or harvesters, and has a housing with an upper wall and a lower wall that are interconnected by two side walls. Disposed in the rear end of the housing is a drive shaft that extends through the side walls and is fixedly connected with chain or sprocket wheels. Disposed at the front end of the housing is a further shaft that also extends through the side walls of the housing. This shaft accommodates a guide roller. Further endless pulling means, in the form of chains that extend parallel to one another, are part of the conveying mechanism; the chains are guided over the guide roller and the sprocket wheels of the drive shaft. The chains are driven by the sprocket wheels of the rear drive shaft. A plurality of rails or strips extend between the chains transverse to the direction of conveyance; the strips are secured to the chains and function as carriers or pick-up elements. During operation of the inclined conveyor, the strips of the lower run of the conveying device convey the harvested material on the lower wall of the housing or possibly on a wear plate upwardly to a further processing unit. To prevent harvested material that still adheres to the conveying device from falling back off of the upper run onto the lower run, where it can thereby wind about the drive shaft or collect on the chain sprockets, an intermediately disposed cover device in the form of plates is provided that is at least partially welded to the side walls of the housing.

To provide the operator of the harvester with access into the interior of the housing, an inspection opening is provided in the upper wall of the housing that is closed off by a lid. After this lid is opened, the interior of the housing can be inspected; it is in particular possible to replace individual ones of the carrier strips or to remove disruptive collections of material in the interior of the housing.

Although the above-described solution makes it possible to inspect the interior of the inclined conveyor and to undertake minor repairs, such as the replacement of carrier strips, it has no advantages if the objective is, for example, to replace the entire endless conveyor. For this purpose, it is necessary to pull not only the drive shaft but also the shaft of the guide roller out of the housing. Subsequently, the endless connection of the endless conveyor must be released so that it could be pulled out of the housing. The subsequent mounting of a new endless conveyor occurs in the reverse sequence and is also very complicated.

It is therefore an object of the present invention to provide a conveying system for agricultural machines of the aforementioned general type that enables a rapid replaceability of the conveying mechanism, as well as good accessibility for cleaning or removing material accumulations.

This object is inventively realized with a conveying system having the features of claim 1. Accordingly, the conveying system is provided with a conveying mechanism in the form of a module and comprised of drive mechanisms and guide mechanisms and an endless conveyor, whereby the drive mechanisms and the guide mechanisms are mounted in a self-supporting frame structure of the module. For installation, the module is simply placed into the housing and is detachably connected therewith. After release of this connection, the module can be rapidly replaced by removing it from the housing. This might be required if damage to the conveying mechanism results or for maintenance purposes. A rapid exchangability of the module is also advantageous if the agricultural machine is to be converted for use with a different material that is to be harvested. Since the module can be removed from the housing as a whole, excellent accessibility results for cleaning or for removing accumulations of material. Furthermore, when the module is removed, the endless conveyor can be easily assembled or disassembled in that it is simply laterally placed onto or withdrawn from the drive mechanisms and the guide mechanisms of the module. The type of endless connection of the endless conveyor is in this case not important. For example, the endless connection can, for example, be comprised of a lock bolt, an incremental, post-vulcanized connection, or the endless conveyor can also be endlessly wound.

The housing of the inventive conveying system can also have a variety of configurations. For example, it can be a chute that is open toward the front and toward the rear, but is otherwise closed off on all sides, or it can be a channel that is closed off only at the sides and is otherwise open. Furthermore, a housing in the form of a frame or rack is also conceivable. Depending upon the design of the housing, introduction of the module into the housing is effected by insertion from the front, from the rear, or from the side, or also by insertion from above or from below.

Advantageous configurations of the present invention are found in the dependent claims.

The present invention will be described in detail subsequently with the aid of a specific embodiment. The accompanying drawings show:

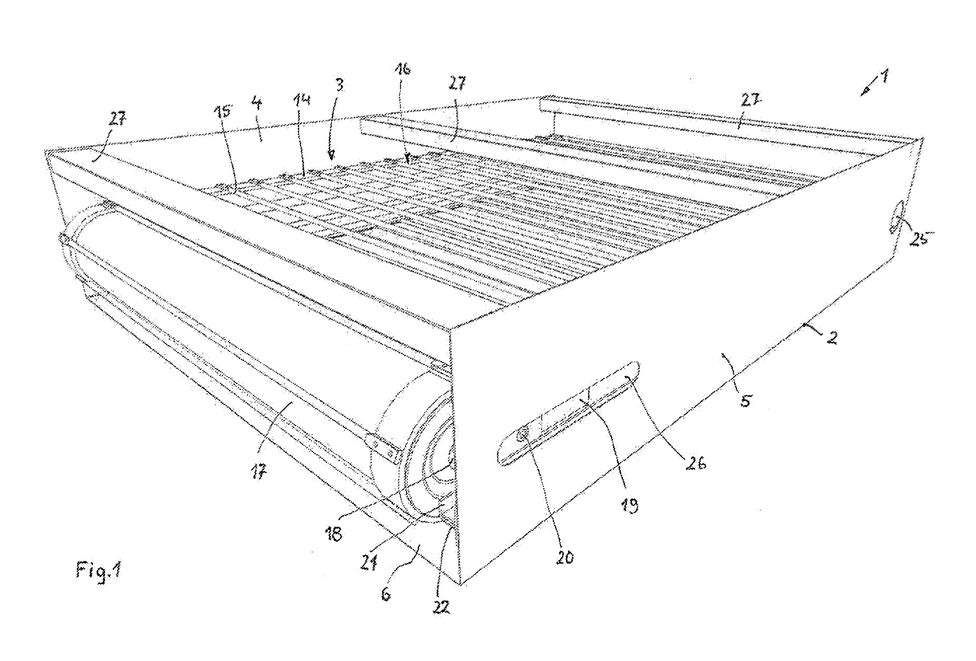

FIG. 1 a prospective view at an angle from above onto one inventive configuration of a conveying system for agricultural machines, comprised of a modular conveying mechanism and a housing,

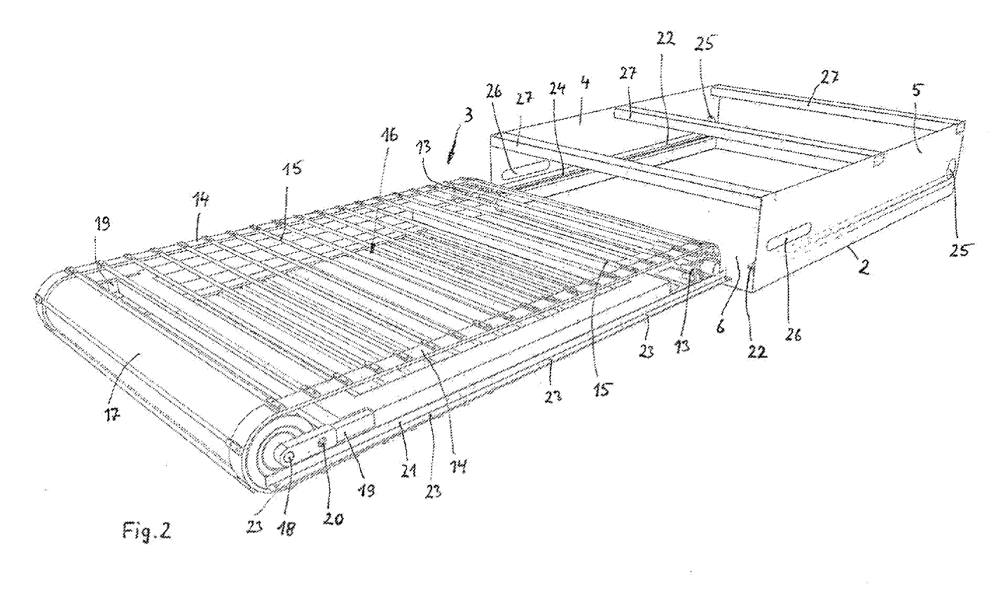

FIG. 2 an illustration pursuant to FIG. 1 with the conveying mechanism withdrawn from the housing, and

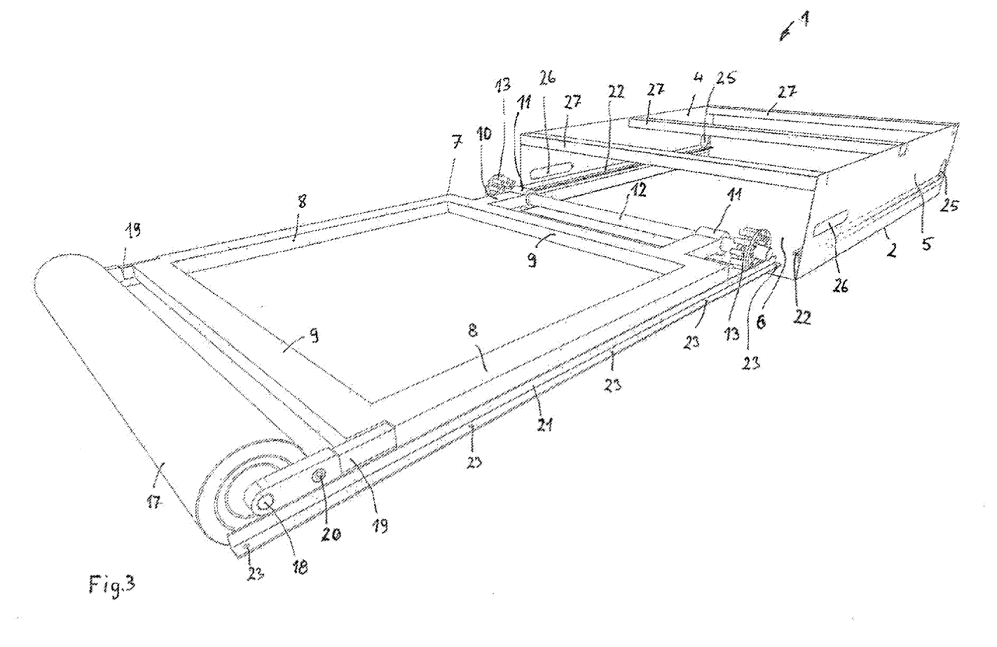

FIG. 3 an illustration pursuant to FIG. 2 with the conveyor belt omitted.

The conveying system 1 illustrated in the drawings is comprised of a housing 2 and a modular conveying mechanism 3 disposed therein. The housing 2 is provided with two side walls 4 and 5, the bottom edges of which are interconnected by a base plate 6. The upper edges of the side walls 4 and 5 are reinforced or braced relative to one another by transverse or cross members 27. Other than the cross members, the housing 2 is open at its end faces and toward the top. The housing is installed in a non-illustrated agricultural machine.

The conveying mechanism 3 is provided with a self-supporting frame structure 7 that includes two longitudinal members 8 and two transverse members 9 that connect them. Two support arms 10 project monolithically rearwardly from the rear transverse member 9 as viewed in the direction of installation; formed at the free ends of the two support arms 10 are mounting supports 11 for a driven shaft 12. Fixedly seated on each of the ends of the driven shaft 12 that extend laterally out of the mounting supports 11 are cam or lug wheels 13 that serve for driving two cam or lug belts 14 that extend parallel to one another and on which are secured bars or rods 15 that are oriented transverse to the direction of conveyance. The two cam belts 14 and the bars 15 together form a belt band with bars 16. The forward end of the belt band with bars 16 rotates or runs about a guide roller 17, which is not driven and the spindles 18 of which are rotatably mounted in telescopic tensioning arms 19 that on both sides extend toward the front from the longitudinal members 8. The length of the tensioning arms 19 can be adjusted via a control opening 20, for example by use of a tightening key, so that the belt band with bars 16, which runs over the cam or lug wheels 13 and the guide roller 17, can be tensioned prior to installation of the conveying mechanism 3 into the housing 2.

A respective L-shaped rail 21 is secured to the outer side of the longitudinal members 18. These rails 21 serve for the introduction of the conveying mechanism 3 into the housing 2. For this purpose, similarly L-shaped rails 22 are secured to the inner sides of the side walls 4 and 5 of the housing 2. When the conveying mechanism 3 is introduced into the housing 2, the horizontal legs of the rails 21 slide on the horizontal legs of the rails 22 of the housing 2. After introduction of the conveying mechanism 3 into the housing 2, they are detachably screwed or bolted to one another. For this purpose, bores or holes 23 and 24 are provided in the horizontal legs of the rails 21 and 22 perspectively in order to establish the threaded or bolted connections. Since the housing 2 is open toward the top, a good accessibility to these connection locations is provided. If the upper sides of the housing 2 were also closed, the conveying mechanism 3 could be bolted or screwed to the housing 2, for example through the side walls 4 and 5.

To connect the driven shaft 12 of the conveying mechanism 3 with a drive mechanism in the installed state, access openings 25 are provided at the rear ends of the side walls 4 and 5 through which the driven shaft 12 can be connected via couplings with a non-illustrated drive mechanism. To be able to re-tighten the belt band with bars 16 even when the conveying mechanism 3 is installed in the housing 2, slots 26 are provided in the forward region of the side walls 4 and 5 via which the control openings 20 of the tensioning arms 19 are accessible for a tightening tool.

For repair, maintenance, modification or cleaning purposes, after unscrewing the bolt or thread connections between the conveying mechanism and the housing 2, the conveying mechanism 3 as a whole can be pulled out of the housing. In so doing, in this way, not only are all of the functional components of the conveying mechanism 3 very accessible, but the interior of the housing 2 is also very accessible.

We claim:

1-3. (canceled)

4. A conveying system for agricultural machines, comprising:
a housing (2), and
a modular conveying mechanism (3) configured to be introduced into said housing (2) and to be detachably connected to said housing, wherein said conveying mechanism (3) is provided with drive mechanisms (12, 13) and guide mechanisms (17, 18), further wherein said conveying mechanism (3) includes an endless conveyor that rotates about said drive mechanisms (12, 13) and said guide mechanisms (17, 18), and wherein said conveying mechanism (3) is provided with a self-supporting frame structure (7-10, 19) in which said drive mechanisms (12, 13) and said guide mechanisms (17, 18) are rotatably mounted.

5. A conveying system according to claim 4, wherein said housing (2) is provided with cut-away portions (25, 26) that enable access from the outside of said housing (2) to functional components (12, 19) of said conveying mechanism (3).

6. A conveying system according to claim 4, wherein said conveying mechanism (3) and also said housing (2) are respectively provided with auxiliary means (21, 22) that permit a properly positioned insertion of said conveying mechanisms (3) into said housing (2).
